(19) United States
(12) Patent Application Publication
(10) Pub. No.: US 2025/0116528 A1
(43) Pub. Date: Apr. 10, 2025

(54) MAP GENERATION APPARATUS AND MAP GENERATION SYSTEM

(71) Applicant: Honda Motor Co., Ltd., Tokyo (JP)

(72) Inventor: Naoki Mori, Tokyo (JP)

(21) Appl. No.: 18/903,131

(22) Filed: Oct. 1, 2024

(30) Foreign Application Priority Data
Oct. 5, 2023 (JP) 2023-173381

(51) Int. Cl. G01C 21/00; B60W 50/14; B60W 60/00

(52) U.S. Cl. CPC G01C 21/3833; B60W 50/14; B60W 60/001; G01C 21/3815; G01C 21/3896; B60W 2050/146; B60W 2556/10; B60W 2556/40; B60W 2556/45

(57) ABSTRACT

A map generation apparatus includes a microprocessor configured to perform: recognizing a surrounding environment based on detection data of a sensor; generating a map based on recognition information; estimating a position of the subject vehicle on the map; determining completion or incompletion of the map; and storing map information. The generating includes: generating the map of a driving section based on the recognition information; storing, in a memory, the map information corresponding to a completion section; and storing, in the memory, section information indicating an incompletion section together with position information of the subject vehicle. The generating further includes: when the subject vehicle travels next time on the incompletion section, generating a map of the incompletion section based on the recognition information; adding map information of the incompletion section to the map information; and rewriting the section information.

### CROSS-REFERENCE TO RELATED APPLICATION

This application is based upon and claims the benefit of priority from Japanese Patent Application No. 2023-173381 filed on Oct. 5, 2023, the content of which is incorporated herein by reference.

### BACKGROUND

### Technical Field

The present invention relates to a map generation apparatus and map generation system configured to generate a map used for estimating a position of a subject vehicle.

### Related Art

As this type of apparatus, there has been conventionally known an apparatus configured to create maps using feature points that have been extracted from captured images acquired by a camera mounted on a vehicle while traveling (see, for example, JP 2019-174910 A).

In the related technique, for example, in a case where another lane other than a driving lane is hidden by the influence of another vehicle that is traveling, or in a case where there are many driving lanes on a road and a map of such a road cannot be made at one time, precision of map information has been impaired in some cases.

Generating a map necessary for vehicle control enables smooth movement of the vehicle, thereby leading to improvement of traffic convenience and safety. This enables a contribution to development of a sustainable transportation system.

### SUMMARY

An aspect of the present invention is a map generation apparatus including: a sensor configured to detect an exterior environment situation of a subject vehicle; and a microprocessor and a memory coupled to the microprocessor. The microprocessor is configured to perform: recognizing a surrounding environment based on detection data of the sensor; generating a map based on recognition information acquired in the recognizing; estimating a position of the subject vehicle on the map; determining completion or incompletion of the map; and storing map information indicating the map. The microprocessor is configured to perform the generating including: generating the map of a driving section based on the recognition information; storing, in the memory, the map information corresponding to a completion section determined that the map is complete; and storing, in the memory, section information indicating an incompletion section determined that the map is incomplete, together with position information indicating the position of the subject vehicle, and the generating further including: when the subject vehicle travels next time on the incompletion section, generating a map of the incompletion section based on the recognition information acquired based on the detection data of the sensor; adding a map information indicating the map of the incompletion section to the map information stored in the memory; and rewriting the section information stored in the memory.

### BRIEF DESCRIPTION OF DRAWINGS

The objects, features, and advantages of the present invention will become clearer from the following description of embodiments in relation to the attached drawings, in which:

FIG. 1 is a block diagram schematically illustrating an overall configuration of a vehicle control system of a subject vehicle including a map generation apparatus according to an embodiment of the present invention;

FIG. 2 is a block diagram illustrating a main configuration of the map generation apparatus according to an embodiment;

FIG. 3A is a diagram illustrating an example of the camera;

FIG. 3B is a diagram illustrating extracted feature points;

FIG. 3C is a diagram illustrating selected feature points;

FIG. 4A is a flowchart illustrating an example of processing executed by the controller in FIG. 2;

FIG. 4B is a flowchart illustrating an example of processing executed by the controller in FIG. 2;

FIG. 4C is a flowchart illustrating an example of processing executed by the controller in FIG. 2; and

FIG. 5 is a diagram illustrating a configuration of a map generation system according to a third modification.

### DETAILED DESCRIPTION

An embodiment of the present invention will be described below with reference to FIGS. A map generation apparatus according to the embodiment of the present invention can be applied to a vehicle having a self-driving capability, that is, a self-driving vehicle. Note that a vehicle to which the map generation apparatus according to the present embodiment is applied may be referred to as a subject vehicle to be distinguished from other vehicles. The subject vehicle may be any of an engine vehicle including an internal combustion (engine) as a traveling drive source, an electric vehicle including a traveling motor as a traveling drive source, and a hybrid vehicle including an engine and a traveling motor as a traveling drive source. The subject vehicle can travel not only in a self-drive mode in which a driving operation by a driver is unnecessary, but also in a manual drive mode by the driving operation by the driver.

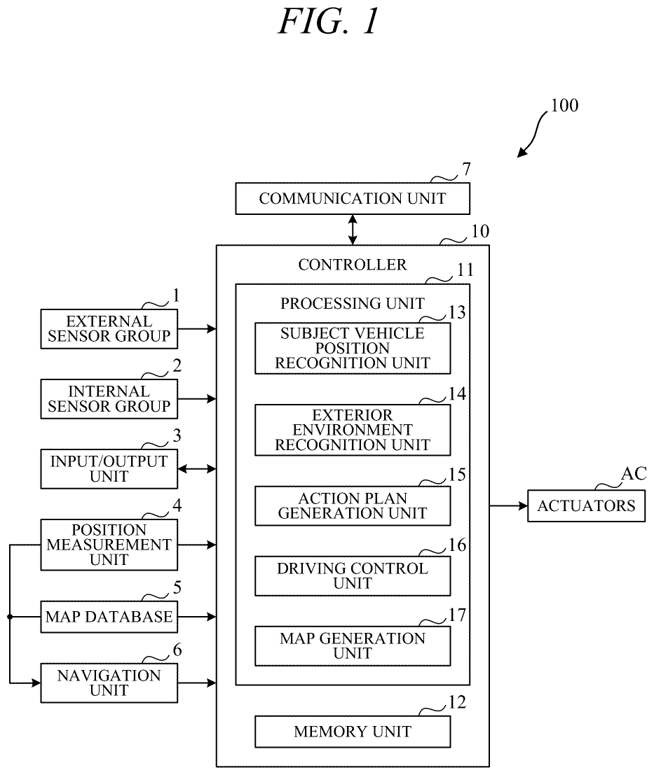

First, a schematic configuration of the subject vehicle related to self-driving will be described. FIG. 1 is a block diagram schematically illustrating an overall configuration of a vehicle control system 100 of the subject vehicle including the map generation apparatus according to the embodiment of the present invention. As illustrated in FIG. 1, the vehicle control system 100 mainly includes a controller 10, an external sensor group 1, an internal sensor group 2, an input/output device 3, a position measurement unit 4, a map database 5, a navigation unit 6, a communication unit 7, and actuators AC each communicably connected to the controller 10.

The external sensor group 1 is a generic term for a plurality of sensors (external sensors) that detects an external situation which is peripheral information of the subject vehicle. For example, the external sensor group 1 includes a LiDAR that measures scattered light with respect to irradiation light in all directions of the subject vehicle and measures a distance from the subject vehicle to surrounding obstacles, a radar that detects other vehicles, obstacles, and the like around the subject vehicle by emitting electromagnetic waves and detecting reflected waves, a camera that is mounted on the subject vehicle, has an imaging element (image sensor) such as a charge coupled device (CCD) or a complementary metal oxide semiconductor (CMOS), and images a periphery (forward, backward, and sideward) of the subject vehicle, and the like.

The internal sensor group 2 is a generic term for a plurality of sensors (internal sensors) that detects a traveling state of the subject vehicle. For example, the internal sensor group 2 includes a vehicle speed sensor that detects a vehicle speed of the subject vehicle, an acceleration sensor that detects an acceleration in a front-rear direction of the subject vehicle and an acceleration in a left-right direction (lateral acceleration) of the subject vehicle, a revolution sensor that detects the number of revolution of the traveling drive source, a yaw rate sensor that detects a rotation angular speed around a vertical axis of the centroid of the subject vehicle, and the like. The internal sensor group 2 further includes a sensor that detects driver's driving operation in a manual drive mode, for example, operation of an accelerator pedal, operation of a brake pedal, operation of a steering wheel, and the like.

The input/output device 3 is a generic term for devices in which a command is input from a driver or information is output to the driver. For example, the input/output device 3 includes various switches to which the driver inputs various commands by operating an operation member, a microphone to which the driver inputs a command by voice, a display that provides information to the driver via a display image, a speaker that provides information to the driver by voice, and the like.

The position measurement unit (global navigation satellite system (GNSS) unit) 4 includes a position measurement sensor that receives a signal for position measurement transmitted from a position measurement satellite. The position measurement satellite is an artificial satellite such as a global positioning system (GPS) satellite or a quasi-zenith satellite. The position measurement unit 4 uses the position measurement information received by the position measurement sensor to measure a current position (latitude, longitude, and altitude) of the subject vehicle.

The map database 5 is a device that stores general map information used for the navigation unit 6, and is constituted of, for example, a hard disk or a semiconductor element. The map information includes road position information, information on a road shape (curvature or the like), and position information on intersections and branch points. Note that the map information stored in the map database 5 is different from highly accurate map information stored in a memory unit 12 of the controller 10.

The navigation unit 6 is a device that searches for a target route on a road to a destination input by a driver and provides guidance along the target route. The input of the destination and the guidance along the target route are performed via the input/output device 3. The target route is calculated on the basis of a current position of the subject vehicle measured by the position measurement unit 4 and the map information stored in the map database 5. The current position of the subject vehicle can be also measured using the detection value of the external sensor group 1, and the target route may be calculated on the basis of the current position and the highly accurate map information stored in the memory unit 12.

The communication unit 7 communicates with various servers not illustrated via a network including wireless communication networks represented by the Internet, a mobile telephone network, and the like, and acquires the map information, traveling history information, traffic information, and the like from the server periodically or at an arbitrary timing. The communication unit 7 may not only acquire the driving history information but also send the driving history information of the subject vehicle to a server via the communication unit 7. The network includes not only a public wireless communication network but also a closed communication network provided for each predetermined management region, for example, a wireless LAN, Wi-Fi (registered trademark), Bluetooth (registered trademark), and the like. The acquired map information is output to the map database 5 and the memory unit 12, and the map information is updated.

The actuators AC are traveling actuators for controlling traveling of the subject vehicle. In a case where the traveling drive source is an engine, the actuators AC include a throttle actuator that adjusts an opening (throttle opening) of a throttle valve of the engine. In a case where the traveling drive source is a traveling motor, the traveling motor is included in the actuators AC. The actuators AC also include a brake actuator that operates a braking device of the subject vehicle and a steering actuator that drives a steering device.

The controller 10 includes an electronic control unit (ECU). More specifically, the controller 10 includes a computer that has a processing unit 11 such as a central processing unit (CPU) (microprocessor), the memory unit 12 such as a read only memory (ROM) and a random access memory (RAM), and other peripheral circuits (not illustrated) such as an input/output (I/O) interface. Note that although a plurality of ECUs having different functions such as an engine control ECU, a traveling motor control ECU, and a braking device ECU can be separately provided, in FIG. 1, the controller 10 is illustrated as a set of these ECUs for convenience.

The memory unit 12 stores highly accurate detailed map information (referred to as highly accurate map information). The highly accurate map information includes road position information, information of a road shape (curvature or the like), information of a road gradient, position information of an intersection or a branch point, information of type and position of a division line of a road, information of the number of lanes, width of a lane and position information for each lane (information of a center position of a lane or a boundary line of a lane position), position information of a landmark (traffic lights, signs, buildings, etc.) as a mark on a map, and information of a road surface profile such as unevenness of a road surface. In the embodiment, the median line, lane boundary line, and roadway outside line are collectively referred to as a division line of a road.

The high-precision map information stored in the memory unit 12 includes map information (referred to as external map information) that has been acquired from the outside of the subject vehicle via the communication unit 7, and a map (referred to as internal map information) created by the subject vehicle itself using detection values by the external sensor group 1 or detection values of the external sensor group 1 and the internal sensor group 2.

The external map information is, for example, information of a map that has been acquired via a cloud server (referred to as a cloud map), and the internal map information is, for example, information of a map (referred to as an environmental map) including three-dimensional point cloud data generated by mapping using a technology such as simultaneous localization and mapping (SLAM), for example. The external map information is shared among the subject vehicle and other vehicles, whereas the internal map information is map information that is exclusive to the subject vehicle (for example, map information that the subject vehicle owns by itself). For roads on which the subject vehicle has never traveled, newly constructed roads, and the like, environmental maps are created by the subject vehicle itself. Note that the internal map information may be provided for a server apparatus or other vehicles via the communication unit 7.

In addition to the above-described high-precision map information, the memory unit 12 also stores driving trajectory information of the subject vehicle, various control programs, and thresholds for use in the programs.

The processing unit 11 includes a subject vehicle position recognition unit 13, an exterior environment recognition unit 14, an action plan generation unit 15, a driving control unit 16, and a map generation unit 17 as functional configurations.

The subject vehicle position recognition unit 13 recognizes (may be referred to as estimates) the position (subject vehicle position) of the subject vehicle on a map, on the basis of the position information of the subject vehicle, obtained by the position measurement unit 4, and the map information of the map database 5. The subject vehicle position may be recognized (estimated) using the high-precision map information stored in the memory unit 12 and the peripheral information of the subject vehicle detected by the external sensor group 1, whereby the subject vehicle position can be recognized with high precision. The subject vehicle position can be also recognized by calculating movement information (movement direction, distance traveled) of the subject vehicle based on the detection values of the internal sensor group 2. Note that when the subject vehicle position can be measured by a sensor installed on the road or outside a road side, the subject vehicle position can be recognized by communicating with the sensor via the communication unit 7.

The exterior environment recognition unit 14 recognizes an external situation around the subject vehicle on the basis of the signal from the external sensor group 1 such as a LiDAR, a radar, and a camera. For example, the position, travel speed, and acceleration of a surrounding vehicle (a forward vehicle or a rearward vehicle) traveling around the subject vehicle, the position of a surrounding vehicle stopped or parked around the subject vehicle, the positions and states of other objects and the like are recognized. Other objects include signs, traffic lights, markings (road marking) such as division lines and stop lines of roads, buildings, guardrails, utility poles, signboards, pedestrians, bicycles, and the like. The states of other objects include a color of a traffic light (red, blue, yellow), the moving speed and direction of a pedestrian or a bicycle, and the like. Some of objects that are stationary among the other objects make up landmarks that indicate the position on the map, and the exterior environment recognition unit 14 also recognizes position and type of the landmarks.

The action plan generation unit 15 generates a driving path (target path) of the subject vehicle from a current point of time to a predetermined time ahead on the basis of, for example, the target route calculated by the navigation unit 6, the high-precision map information stored in the memory unit 12, the subject vehicle position recognized by the subject vehicle position recognition unit 13, and the external situation recognized by the exterior environment recognition unit 14. When there is a plurality of paths that are candidates for the target path on the target route, the action plan generation unit 15 selects, from among the plurality of paths, an optimal path that satisfies criteria such as compliance with laws and regulations and efficient and safe traveling, and sets the selected path as the target path. Then, the action plan generation unit 15 generates an action plan corresponding to the generated target path. The action plan generation unit 15 generates various action plans corresponding to overtaking traveling for overtaking a preceding vehicle, lane change traveling for changing a travel lane, following traveling for following a preceding vehicle, lane keeping traveling for keeping the lane so as not to deviate from the travel lane, deceleration traveling, or acceleration traveling. When the action plan generation unit 15 generates the target path, the action plan generation unit 15 first determines a travel mode, and generates the target path on the basis of the travel mode.

In the self-drive mode, the driving control unit 16 controls each of the actuators AC such that the subject vehicle travels along the target path generated by the action plan generation unit 15. More specifically, the driving control unit 16 calculates a requested driving force for obtaining the target acceleration for each unit time calculated by the action plan generation unit 15 in consideration of travel resistance determined by a road gradient or the like in the self-drive mode. Then, for example, the actuators AC are feedback controlled so that an actual acceleration detected by the internal sensor group 2 becomes the target acceleration. That is, the actuators AC are controlled so that the subject vehicle travels at the target vehicle speed and the target acceleration. Note that, in the manual drive mode, the driving control unit 16 controls each of the actuators AC in accordance with a travel command (steering operation or the like) from the driver acquired by the internal sensor group 2.

The map generation unit 17 generates an environmental map in the surroundings of the road on which the subject vehicle has traveled, as internal map information, by using the detection values that have been detected by the external sensor group 1 while the subject vehicle is traveling in the manual drive mode. For example, an edge indicating an outline of an object is extracted from a plurality of frames of camera images that have been acquired by the camera, based on luminance and color information for every pixel, and feature points are extracted with use of such edge information. The feature points are, for example, intersections of edges, and correspond to corners of buildings, corners of road signs, or the like. The map generation unit 17 calculates a three-dimensional position of a feature point while estimating the position and attitude of the camera so that identical feature points converge on a single point in a plurality of frames of camera images, in accordance with the algorithm of the SLAM technology. By performing this calculation processing for each of the plurality of feature points, an environmental map including the three-dimensional point cloud data is generated.

Note that, instead of the camera, with use of data acquired by a radar or a LiDAR, the environmental map may be generated by extracting feature points of objects in the surroundings of the subject vehicle.

In addition, in generating the environmental map, upon determination that a ground object (examples including a division line of a road, a traffic light, and a traffic sign) that is important in terms of a map is included in a camera image in accordance with object detection in pattern matching processing or the like, the map generation unit 17 adds position information of a point corresponding to a feature point of the ground object based on the camera image to the environmental map, and stores the position information in the memory unit 12.

The subject vehicle position recognition unit 13 performs position recognition processing of the subject vehicle in parallel with map creation processing by the map generation unit 17. That is, the position of the subject vehicle is estimated, based on a change in the position of the feature point over time. The map creation processing and the position recognition (estimation) processing are simultaneously performed in accordance with, for example, the algorithm of the SLAM technology. The map generation unit 17 is capable of generating the environmental map not only when traveling in the manual drive mode but also when traveling in the self-drive mode. In a case where the environmental map has already been generated and stored in the memory unit 12, the map generation unit 17 may update the environmental map, based on a newly extracted feature point (may be referred to as a new feature point) from a newly acquired camera image.

The feature point for use in generating the environmental map using the SLAM technology, by the way, has to be a unique feature point to be easily distinguished from another feature point. On the other hand, in actual vehicle control, for example, information of the ground object such as a division line of a road has to be included in the environmental map. In an embodiment, a map generation apparatus that performs the following processing (1) to (4) is configured, and thereby an environmental map including information necessary for the vehicle control is generated appropriately.

(1) For a feature point for use in generating the environmental map, a unique feature point that is easily distinguished from other feature points is selected from the feature points extracted from camera images. This is because unless the feature point is unique, it is difficult to track an identical feature point between the camera images of a plurality of frames. For this reason, a unique feature point based on edge information such as a window frame of a building is selected on a priority basis, whereas selection of a feature point based on edge information of a predetermined ground object such as a division line of a road, a traffic sign, and a traffic signal where it is difficult to track the identical feature point between the camera images of the plurality of frames is avoided.

(2) Information useful for recognition (estimation) of the position of the subject vehicle is added to the environmental map afterward. In the above (1), the information of a division line of the road or the like necessary for recognizing the position of the subject vehicle is not included in the environmental map, so the information of the division line or the like is added (may be referred to as embedded) to the environmental map afterward.

(3) When the environmental map is compensated, the information that has been added afterward in the above (2) is added again. Generally, in the SLAM technology, the subject vehicle recognizes the position of the subject vehicle, while the subject vehicle is moving. Therefore, errors are accumulated. For example, when the subject vehicle moves around a closed loop-like road having a rectangular shape, the positions of the start point and the end point do not match due to accumulated errors. Hence, when it is recognized that the position where the subject vehicle is traveling is located on the driving trajectory in the past, loop closing processing is performed to set the same coordinates between the position of the subject vehicle that has been recognized with use of a feature point extracted from a newly acquired camera image (referred to as a new feature point) on the same travel point as in the past and the position of the subject vehicle that has been recognized in the past with use of a feature point extracted from a camera image that has been acquired when traveling in the past. In an embodiment, the loop closing processing will be referred to as compensation of the environmental map, and information of the three-dimensional position included in the environmental map is compensated. In this situation, the information that has been added in the above (2) is deleted, and is added again to the environmental map after compensation.

(4) The completion of the environmental map is determined. Specifically, whether an environmental map necessary for safe vehicle control has been generated is checked. In a case where the completion of the environmental map is not determined, section information of such a driving section is stored in the memory unit 12, and a map is generated, based on feature points that have been extracted from a camera image to be newly acquired when the subject vehicle travels in such a section next time. In a case where the completion of the environmental map is determined, the environmental map can be used for the vehicle control in the self-driving in the driving section.

Four points (a) to (d) to be given as examples in the following are specific examples for determining that the environmental map is not completed.
(a) A case where there is a defect (may be referred to as not enough or insufficient) in the recognition information acquired while the subject vehicle is traveling
(b) A case where, while the subject vehicle is traveling in the self-drive mode for the completion determination of the environmental map, the driving control unit 16 degenerates the self-driving level of the self-drive mode to a level lower than the current level.
(c) A case where, while the subject vehicle is traveling in the self-drive mode using the environmental map, a signal indicating that the driver has intervened in a driving operation is input from the internal sensor group 2.
(d) A case where a difference between a position of a new feature point that has been obtained, based on a position of a division line or the like that appears in a newly acquired camera image, and a position of a point corresponding to a feature point of a division line or the like that is stored in the environmental map that has been generated in a previous traveling time exceeds a predetermined value.

In an embodiment, in a case where at least one of the above (a) to (d) is satisfied, the completion of the environmental map is not determined, and the map is generated again, based on the feature point that has been extracted from the camera image to be newly acquired, when the subject vehicle travels in the same section next time.

Note that the case where there is a defect in the recognition information that has been acquired while the subject vehicle is traveling in the above (a) corresponds to, for example, a case where the lane adjacent to the driving lane is hidden by the influence of another vehicle that is traveling, and as a result, it is not possible to create a map of a road including another lane other than the driving lane (a case where the map is incomplete as an environmental map even though it is possible to create the map is included), and a case where there are a large number of lanes on the road on which the subject vehicle is traveling and there is a lane out of the angle of view of the camera (the side of the road does not appear), and as a result, it is not possible to create a map of a road for a lane that does not appear in the camera image (a case where the map is incomplete as an environmental map even though it is possible to create the map is included).

A map generation apparatus for performing processing of the above (1) to (4) will be described in more detail.

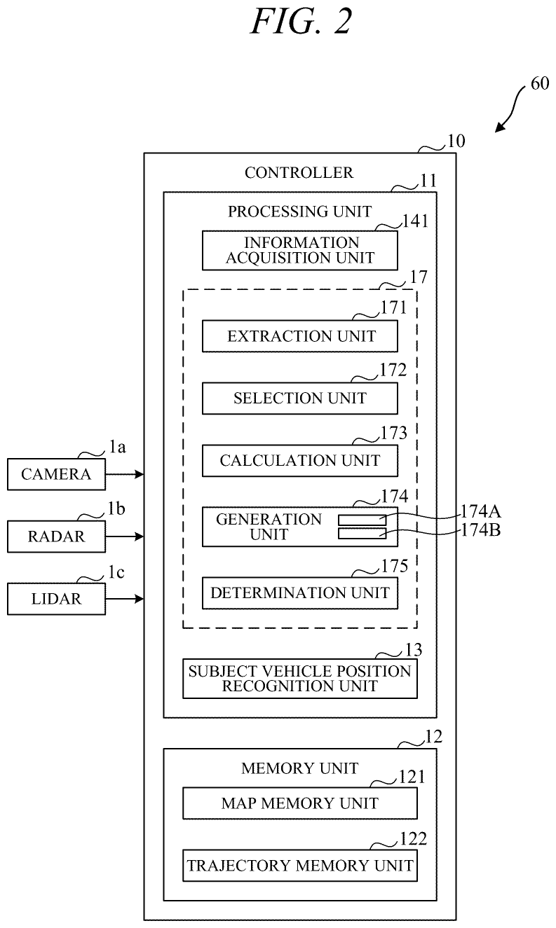

FIG. 2 is a block diagram illustrating a main configuration of a map generation apparatus 60 according to an embodiment. The map generation apparatus 60 controls the driving operation of the subject vehicle, and constitutes a part of the vehicle control system 100 of FIG. 1. As illustrated in FIG. 2, the map generation apparatus 60 includes the controller 10, a camera 1a, a radar 1b, and a LiDAR 1c.

The camera 1a constitutes a part of the external sensor group 1 of FIG. 1. The camera 1a may be a monocular camera or a stereo camera, and captures images of the surroundings of the subject vehicle. The camera 1a is attached to, for example, a predetermined position in a front part of the subject vehicle, continuously captures images of a space on a forward side of the subject vehicle at a predetermined frame rate, and sequentially outputs frame image data (simply referred to as camera images) as detection information to the controller 10.

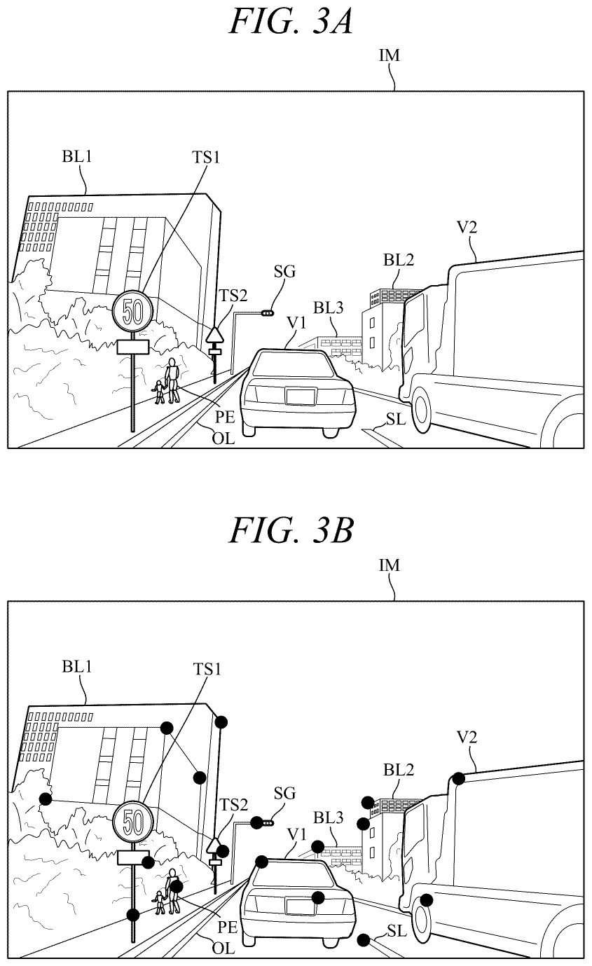

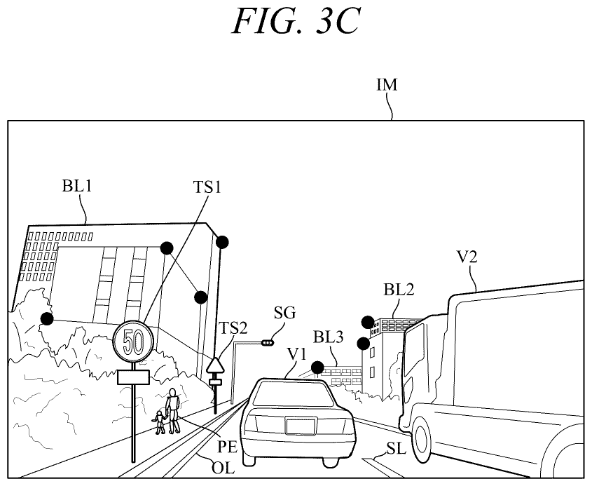

FIG. 3A is a diagram illustrating an example of the camera image of a certain frame acquired by the camera 1a. A camera image IM includes another vehicle V1, which is traveling on a forward side of the subject vehicle, another vehicle V2, which is traveling on a right lane of the subject vehicle, a traffic light SG in the surroundings of the subject vehicle, a pedestrian PE, traffic signs TS1 and TS2, buildings BL1, BL2 and BL3 in the surroundings of the subject vehicle, a roadway outside line OL, and a lane boundary line SL.

The radar 1b of FIG. 2 is mounted on the subject vehicle, irradiates electromagnetic waves, detects reflected waves, and detects other vehicles, obstacles, and the like in the surroundings of the subject vehicle. The radar 1b outputs detection values (detection data) as detection information to the controller 10. The LiDAR 1c is mounted on the subject vehicle, measures scattered light with respect to irradiation light in all directions of the subject vehicle, and detects a distance from the subject vehicle to an obstacle in the surroundings. The LiDAR 1c outputs detection values (detection data) as detection information to the controller 10.

The controller 10 includes the processing unit 11 and the memory unit 12. The processing unit 11 includes an information acquisition unit 141, an extraction unit 171, a selection unit 172, a calculation unit 173, a generation unit 174, a determination unit 175, and the subject vehicle position recognition unit 13, as functional configurations.

The information acquisition unit 141 is included in, for example, the exterior environment recognition unit 14 of FIG. 1. The extraction unit 171, the selection unit 172, the calculation unit 173, the generation unit 174, and the determination unit 175 are included in, for example, the map generation unit 17 of FIG. 1.

In addition, the memory unit 12 includes a map memory unit 121 and a trajectory memory unit 122.

The information acquisition unit 141 acquires information used for controlling the driving operation of the subject vehicle from the memory unit 12 (the map memory unit 121). More specifically, the information acquisition unit 141 reads landmark information included in the environmental map from the map memory unit 121, and further acquires, from the landmark information, information indicating the positions of division lines of the road on which the subject vehicle is traveling and extending directions of those division lines (hereinafter, referred to as division line information). Note that in a case where the division line information does not include the information indicating the extending directions of the division lines, the information acquisition unit 141 may calculate the extending directions of the division lines, based on the position of the division lines. Further, information indicating the positions and the extending directions of division lines of the road on which the subject vehicle is traveling may be acquired from road map information or a white line map (information indicating the positions of division lines in white, yellow, or the like) stored in the map memory unit 121.

The extraction unit 171 extracts edges indicating the contour of an object from the camera image IM (illustrated in FIG. 3A), which has been acquired by the camera 1a, and also extracts feature points by using edge information. As described above, the feature points are, for example, edge intersections. FIG. 3B is a diagram illustrating the feature points that have been extracted by the extraction unit 171, based on the camera image IM of FIG. 3A. Black circles in the drawing represent the feature points.

The selection unit 172 selects feature points for calculating the three-dimensional position from among the feature points that have been extracted by the extraction unit 171. In an embodiment, as a unique feature point that is easily distinguished from the other feature points, a feature point included in a ground object is selected excluding a predetermined ground object (examples including a division line of a road, a traffic light, and a traffic sign). FIG. 3C is a diagram illustrating feature points that have been selected by the selection unit 172, based on FIG. 3B. Black circles in the drawing represent the feature points. The illustrated predetermined ground objects are merely examples, and at least one of them may be excluded.

The calculation unit 173, while estimating the position and attitude of the camera 1a, calculates the three-dimensional position for the feature points so that the identical feature points converge on a single point in a plurality of frames of the camera image IM. The calculation unit 173 respectively calculates the three-dimensional positions of a plurality of different feature points that have been selected by the selection unit 172.

The generation unit 174 generates an environmental map including three-dimensional point cloud data including information of each three-dimensional position, by using the three-dimensional positions of the plurality of different feature points that have been calculated by the calculation unit 173.

The determination unit 175 determines completion of the environmental map that has been generated by the generation unit 174. As described above, the determination unit 175 determines incompletion for a case corresponding to at least one of the above (a) to (d) and completion for a case corresponding to none of the above (a) to (d). Details of determination processing will be described later.

In addition, the determination unit 175 also has a function as a lane identification unit that identifies, as a specific lane, a driving lane on which the subject vehicle has traveled, based on the position of the subject vehicle that has been estimated by the subject vehicle position recognition unit 13 to be described later, while the subject vehicle is traveling in a driving section for which the completion of the environmental map has not been determined (in other words, incompletion has been determined).

The subject vehicle position recognition unit 13 estimates the position of the subject vehicle on the environmental map, based on the environmental map stored in the map memory unit 121.

First, the subject vehicle position recognition unit 13 estimates the position of the subject vehicle in a vehicle width direction. Specifically, by using machine learning (deep neural network (DNN) or the like), the subject vehicle position recognition unit 13 recognizes the division line of the road included in the camera image IM, which has been acquired by the camera 1a. The subject vehicle position recognition unit 13 recognizes the position and the extending directions of the division lines included in the camera image IM on the environmental map, based on the division line information that has been acquired from the landmark information included in the environmental map stored in the map memory unit 121. Then, the subject vehicle position recognition unit 13 estimates relative positional relationship (positional relationship on the environmental map) between the subject vehicle and the division line in the vehicle width direction, based on the position and the extending directions of the division lines on the environmental map. In this manner, the position of the subject vehicle in the vehicle width direction on the environmental map is estimated.

Next, the subject vehicle position recognition unit 13 estimates the position of the subject vehicle in an advancing direction. Specifically, the subject vehicle position recognition unit 13 recognizes a landmark (for example, a building BL1) from the camera image IM (FIG. 3A), which has been newly acquired by the camera 1a in processing such as pattern matching, and also recognizes feature points on such a landmark from the feature points that have been extracted by the extraction unit 171. Furthermore, the subject vehicle position recognition unit 13 estimates the distance in the advancing direction from the subject vehicle to the landmark, based on the position of the feature points on the landmark that appears in the camera image IM. Note that the distance from the subject vehicle to the landmark may be calculated, based on a detection value of the radar 1b and/or the LiDAR 1c.

The subject vehicle position recognition unit 13 searches for the feature points corresponding to the above landmark in the environmental map stored in the map memory unit 121. In other words, the feature point that matches the feature point of the landmark that has been recognized from the newly acquired camera image IM is recognized from among the plurality of feature points (point cloud data) that constitute the environmental map.

Next, the subject vehicle position recognition unit 13 estimates the position of the subject vehicle in the advancing direction on the environmental map, based on the position of the feature point on the environmental map corresponding to the feature point of the landmark and the distance from the subject vehicle to the landmark in the advancing direction.

As described heretofore, the subject vehicle position recognition unit 13 recognizes the position of the subject vehicle on the environmental map, based on the estimated position of the subject vehicle on the environmental map in the vehicle width direction and in the advancing direction.

The map memory unit 121 stores the information of the environmental map that has been generated by the generation unit 174.

The trajectory memory unit 122 stores information indicating the driving trajectory of the subject vehicle. The driving trajectory is represented, for example, as the subject vehicle position on the environmental map that has been recognized by the subject vehicle position recognition unit 13 while the subject vehicle is traveling. Description of Flowchart

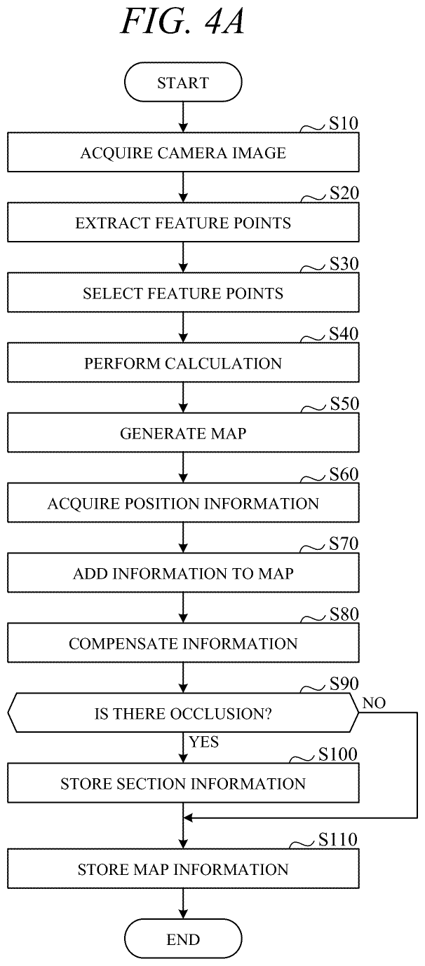

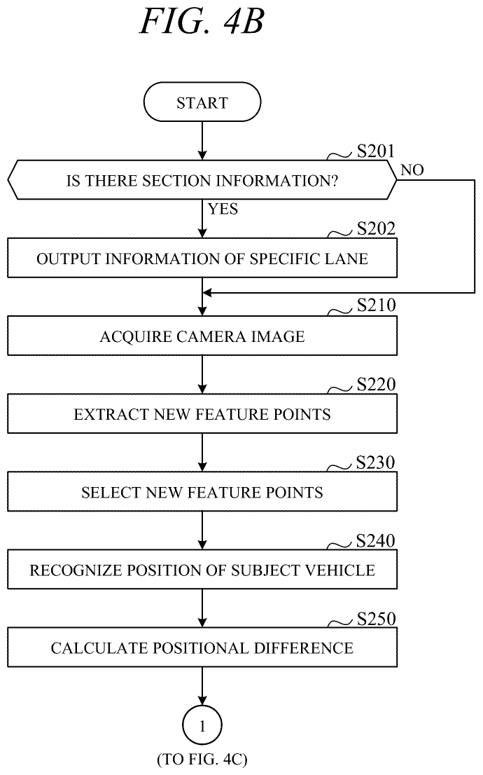

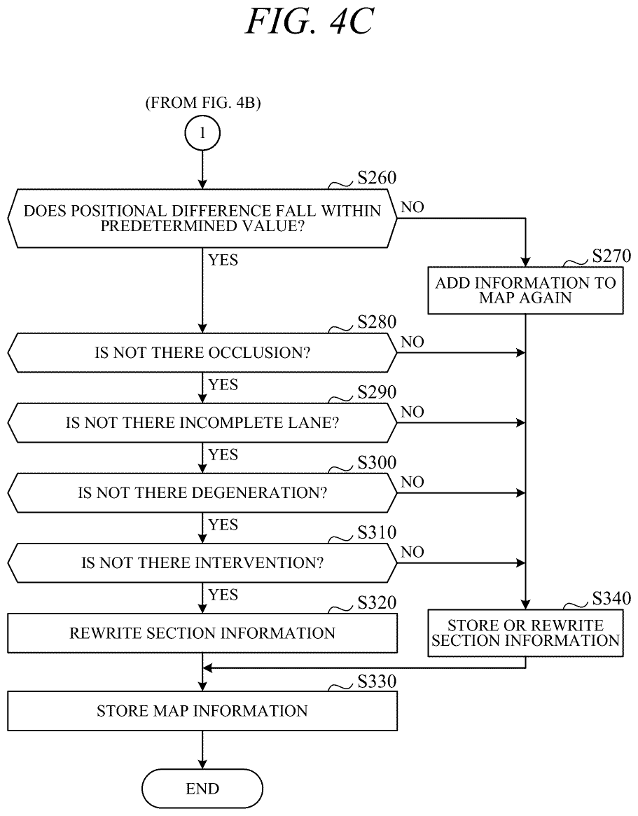

An example of processing to be performed by the controller 10 of FIG. 2 according to a predetermined program will be described with reference to flowcharts of FIGS. 4A, 4B, and 4C. FIG. 4A illustrates processing before the environmental map is created, and the processing is started in, for example, the manual drive mode, and is repeated at a predetermined cycle. FIGS. 4B and 4C illustrate processing to be performed in parallel with the map creation processing of FIG. 4A. In addition, FIGS. 4B and 4C are started in, for example, the self-drive mode after the environmental map is created, and the processing is repeated at a predetermined cycle.

In step S10 of FIG. 4A, the controller 10 acquires the camera image IM as detection information from the camera 1a, and the processing proceeds to step S20.

In step S20, the controller 10 causes the extraction unit 171 to extract feature points from the camera image IM, and the processing proceeds to step S30.

In step S30, the controller 10 causes the selection unit 172 to select feature points, and the processing proceeds to step S40. As described above, by selecting the feature points included in ground objects other than a division line of a road, a traffic light, a traffic sign, and the like, it becomes possible to select a unique feature point that is easily distinguished from the other feature points.

In step S40, the controller 10 causes the calculation unit 173 to respectively calculate the three-dimensional positions of a plurality of different feature points, and the processing proceeds to step S50.

In step S50, the controller 10 causes the generation unit 174 to generate an environmental map including three-dimensional point cloud data including information of the respective three-dimensional positions of the plurality of different feature points, and the processing proceeds to step S60.

In step S60, the controller 10 acquires the position information of a ground object (the distance from the subject vehicle to the ground object) having a feature point that is not selected in step S30 out of the feature points extracted in step S20, in other words, the above predetermined ground object (the division line of the road, the traffic light, the traffic sign, or the like), and the processing proceeds to step S70. Such position information is acquired, for example, by estimating the distance from the subject vehicle to the ground object, based on the position of the feature point of the ground object that appears in the camera image IM. Note that the distance from the subject vehicle to the ground object may be acquired, based on the detection value of the radar 1b and/or the LiDAR 1c.

In step S70, the controller 10 adds the information of the point corresponding to the feature point of the above ground object to the point cloud data of the environmental map, and the processing proceeds to step S80. With such a configuration, the information of a ground object such as the division line is embedded in the environmental map. The information of the division line, the traffic light, and the traffic sign is added to the environmental map, and thus it becomes possible to provide the subject vehicle, based on the information of the environmental map, with the information of the positions of the division line, the traffic light, and the traffic sign that are visible from the position of the subject vehicle and that have been estimated, based on the information of the environmental map.

In step S80, in a case where the controller 10 recognizes that the position where the subject vehicle is traveling is located on the driving trajectory in the past, the controller 10 compensates the information of the three-dimensional position included in the environmental map in the above-described loop closing processing, and the processing proceeds to step S90.

In step S90, the controller 10 determines presence or absence of occlusion. For example, in a case where there is a lane that is hidden by another vehicle V2, and does not appear in the camera image IM, such as the right lane in FIG. 3A, the controller 10 makes an affirmative determination in step S90, and the processing proceeds to step S100. In a case where there is a lane that does not appear in the camera image IM, it is not possible to create the environmental map of the road including such a lane. Therefore, the controller 10 advances the processing to step S100 to leave information indicating the presence of occlusion. On the other hand, in a case where there is no lane that is hidden by another vehicle and does not appear in the camera image IM (in other words, all the lanes directing in the same direction appear in the camera image IM), the controller 10 makes a negative determination in step S90, and the processing proceeds to step S110.

In step S100, the controller 10 stores, in the memory unit 12, section information indicating a section in which the occlusion has been detected while the subject vehicle is traveling, and the processing proceeds to step S110. Note that the section information includes the position information indicating the position of the subject vehicle that has been estimated by the subject vehicle position recognition unit 13.

In step S110, the controller 10 stores, in the map memory unit 121 of the memory unit 12, the map information of the environmental map that has been created in the processing of FIG. 4A, and ends the processing of FIG. 4A.

In step S201 in FIG. 4B, the controller 10 determines presence or absence of the section information. In a case where the above-described section information is stored in the memory unit 12, the controller 10 makes an affirmative determination in step S201, and the processing proceeds to step S202. In a case where the section information is not stored, the controller 10 makes a negative determination in step S201, and the processing proceeds to step S210.

In step S202, the controller 10 outputs the information of a specific lane (hereinafter, referred to as specific lane information) to an external device, and the processing proceeds to step S210. As described above, the specific lane denotes a driving lane on which the subject vehicle has traveled in the driving section for which the incompletion of the environmental map has been determined.

In step S210, the controller 10 acquires the camera image IM, as detection information, from the camera 1a, and the processing proceeds to step S220.

In step S220, the controller 10 causes the extraction unit 171 to extract a new feature point from the camera image IM, and the processing proceeds to step S230. Note that the feature point extracted in the processing of FIG. 4B will be referred to as a new feature point, also in a case where it is located on the same object with the feature point that has been extracted in the processing of FIG. 4A.

In step S230, the controller 10 causes the selection unit 172 to select the new feature point, and the processing proceeds to step S240. In step S230, the new feature point based on edge information of a predetermined ground object (the division line of the road, the traffic sign, the traffic signal, or the like) and the new feature point based on edge information of a building or the like that is not the predetermined ground object are selected.

In step S240, the controller 10 causes the subject vehicle position recognition unit 13 to recognize (estimate) the position of the subject vehicle, based on the environmental map, and the processing proceeds to step S250.

In step S250, the controller 10 calculates the positional difference, and the processing proceeds to step S260 in FIG. 4C. The positional difference denotes a difference between the position of the new feature point of the predetermined ground object selected in step S230 and the position of the point that is added to the environmental map in step S70 and that corresponds to the feature point of the predetermined ground object. The position information of a new feature point of the predetermined ground object is acquired, for example, by estimating the distance from the subject vehicle to the division line or the like, based on the position of the division line or the like that appears in the camera image IM. Note that the distance from the subject vehicle to the division line or the like may be acquired, based on the detection value of the radar 1b and/or the LiDAR 1c.

In step S260 of FIG. 4C, the controller 10 determines whether the positional difference falls within a predetermined value. In a case where the positional difference falls within a predetermined allowable value, the controller 10 makes an affirmative determination in step S260, and the processing proceeds to step S280. The processing proceeds to step S280, in a case where the environmental map has reached a level necessary for the vehicle control in the self-driving, with regard to the positional difference in the area where the subject vehicle has traveled during the processing of FIG. 4B.

On the other hand, in a case where the positional difference exceeds the predetermined value, the controller 10 makes a negative determination in step S260, and the processing proceeds to step S270. The processing proceeds to step S270, in a case where the environmental map has not reached the level necessary for the vehicle control in the self-driving, with regard to the positional difference in the area where the subject vehicle has traveled during the processing of FIG. 4B.

In step S270, the controller 10 deletes the information added to the environmental map in step S70, adds the positional information of the new feature point of the predetermined ground object selected in step S230 to the environmental map again, and the processing proceeds to step S340.

In step S280, the controller 10 determines the presence or absence of occlusion. In a case where the controller 10 makes a negative determination in step S90 during the processing of FIG. 4A (in other words, a case where the section information is not stored in the memory unit 12 during the processing of FIG. 4A), the controller 10 makes an affirmative determination in step S280, and the processing proceeds to step S290. On the other hand, in a case where an affirmative determination is made in step S90 (in other words, in a case where the section information is stored in the memory unit 12 during the processing of FIG. 4A), the controller 10 makes a negative determination in step S280, and the processing proceeds to step S340.

In step S290, the controller 10 determines presence or absence of an incomplete lane. In a case where all the driving lanes of the road on which the subject vehicle travels appear in the camera image IM, which has been acquired during the processing of FIGS. 4A and 4B, the controller 10 makes an affirmative determination in step S290, and the processing proceeds to step S300. On the other hand, in a case where there is a driving lane that does not appear in the camera image IM, which has been acquired during the processing of FIGS. 4A and 4B, the controller 10 makes a negative determination in step S290, and the processing proceeds to step S340.

In step S300, the controller 10 determines presence or absence of degeneration of the self-driving level. While the subject vehicle is traveling in the self-drive mode for determining completion of the environmental map, in a case where the driving control unit 16 does not degenerate the self-driving level in the self-drive mode to a level lower than the current level, the controller 10 makes an affirmative determination in step S300, and the processing proceeds to step S310. On the other hand, in a case where the driving control unit 16 degenerates the self-driving level in the self-drive mode to a level lower than the current level, the controller 10 makes a negative determination in step S300, and the processing proceeds to step S340.

In step S310, the controller 10 determines presence or absence of the intervention in the driving operation. While the subject vehicle is traveling using the environmental map in the self-drive mode, in a case where no signal indicating that the driver intervenes in the driving operation is input from the internal sensor group 2, the controller 10 makes an affirmative determination in step S310, and the processing proceeds to step S320. On the other hand, while the subject vehicle is traveling using the environmental map in the self-drive mode, in a case where a signal indicating that the driver intervenes in the driving operation is input from the internal sensor group 2, the controller 10 makes a negative determination in step S310, and the processing proceeds to step S340.

In step S320, the controller 10 rewrites the section information that has been stored in the memory unit 12 in a past traveling time to the latest information, and the processing proceeds to step S330. In an embodiment, by making an affirmative determination in all of steps S260 and steps S280 to S310, the controller 10 determines the completion of the environmental map. The reason for rewriting the section information stored in the memory unit 12 is to delete old section information indicating the reason for determining that the environmental map has not been completed in the past.

In step S330, the controller 10 stores, in the map memory unit 121 of the memory unit 12, the information of the environmental map that has been generated in the processing of FIG. 4B, and ends the processing of FIG. 4C.

In step S340, the controller 10 stores or rewrites, in the memory unit 12, the section information indicating a section in which the occlusion has been detected during the processing of FIGS. 4B and 4C, a section in which the presence of an incomplete lane has been detected, a section in which the self-driving level has been degenerated, and a section in which the driver has intervened in the driving operation, and the processing proceeds to step S330. As described above, the section information includes the position information indicating the position of the subject vehicle that has been estimated by the subject vehicle position recognition unit 13.

In an embodiment, in a case where an affirmative determination cannot be made in all of steps S260 and steps S280 to S310 (in a case where a negative determination is made in any one of the steps), the controller 10 determines that the environmental map is not completed (incompletion). The reason for storing the section information stored in the memory unit 12 and/or rewriting the section information stored in the memory unit 12 is to rewrite old section information indicating a reason the incompletion of the environmental map has been determined in the past to the latest information.

According to the above-described embodiments, the following effects are achievable.

(1) The map generation apparatus 60 includes: the camera 1a, which detects an exterior environment situation of a subject vehicle that travels; the recognition unit (the exterior environment recognition unit 14) that recognizes a surrounding environment, based on a camera image IM of the camera 1a; the generation unit 174, which generates a map (an environmental map), based on recognition information of the recognition unit; the subject vehicle position recognition unit 13, as a position estimation unit, which estimates a position of the subject vehicle on the map that has been generated by the generation unit 174; the determination unit 175, which determines completion or incompletion of the map that has been generated by the generation unit 174, and the memory unit 12, which stores map information indicating the map that has been generated by the generation unit 174. The generation unit 174 includes: the first generation unit 174A, which generates a map of a driving section, based on the camera image IM, which has been recognized by the camera 1a, stores, in the memory unit 12, map information corresponding to the section for which the completion has been determined by the determination unit 175, and also stores, in the memory unit 12, section information indicating a section for which the incompletion has been determined by the determination unit 175, together with position information of the subject vehicle; and the second generation unit 174B, which generates a map of the section for which the incompletion has been determined, based on the camera image IM of the section that has been recognized by the camera 1a when the subject vehicle travels next time, adds and updates the map information of the section to the map information that has been stored by the first generation unit 174A in the memory unit 12, and rewrites the section information that has been stored by the first generation unit 174A in the memory unit 12.

With such a configuration, in a case where it is not determined that the environmental map necessary for safe vehicle control has been generated (incompletion), the section information of the driving section is stored in the memory unit 12, and it becomes possible to complement the environmental map by adding a newly generated map when the subject vehicle travels in the same section next time. This enables suppression of the driving distance and the number of driving times, and enables prompt completion of the environmental map, as compared with a case where the environmental map of a wide range of driving sections is newly generated again and complemented. In this manner, it becomes possible to appropriately generate the environmental map necessary for safe vehicle control.

(2) The map generation apparatus 60 in the above (1) further includes the controller 10, as an input unit, which inputs information indicating that the degeneration control of the self-driving level has been conducted or the driver of the subject vehicle has intervened in the driving operation from the driving control unit 16, as a control unit, which conducts self-driving control for automatically controlling at least acceleration and deceleration of the subject vehicle, by using the map information stored in the memory unit 12. The determination unit 175 determines the incompletion, when the information is input from the driving control unit 16 to the controller 10 while the self-driving control is being conducted.

With such a configuration, it becomes possible to appropriately determine whether the environmental map necessary for safe vehicle control has been completed.

(3) In the map generation apparatus 60 in the above (1) or (2), the determination unit 175 determines the incompletion, in a case where the camera image IM, which has been recognized by the camera 1a, is insufficient in either information about the driving lane adjacent to the driving lane on which the subject vehicle travels or information about the ground object on a side of a road on which the subject vehicle travels.

With such a configuration, it becomes possible to determine the incompletion for a case where there is a high probability of leading to the degeneration control, if the newly generated environmental map is used for the self-driving control (for example, a state in which occlusion has occurred or a state in which a lane of a road on which the vehicle is traveling is partially out of the angle of view of the camera 1a). It becomes possible to appropriately determine whether the environmental map necessary for safe vehicle control has been completed.

(4) In the map generation apparatus 60 in the above (1) to (3), the determination unit 175 includes a lane identification unit that identifies, as a specific lane, a driving lane on which the subject vehicle has traveled, based on the position of the subject vehicle that has been estimated by the subject vehicle position recognition unit 13, in the section for which the incompletion has been determined.

With such a configuration, for example, by identifying the driving lane on which the subject vehicle has traveled, when the environmental map is not completed due to occlusion, it becomes possible to utilize the information of such a specific lane when the subject vehicle travels next time.

As an example, when the subject vehicle travels next time, by outputting information of the specific lane (specific lane information), when the subject vehicle approaches within a certain distance from the section indicated by the section information stored in the memory unit 12, it becomes possible to request the driver of the subject vehicle to drive on the specific lane or a driving lane different from the specific lane. In this case, in a case where the environmental map has not been completed due to occlusion by another vehicle, information (such as display information, audio information, or the like) for requesting to drive on the specific lane is included in the specific lane information. On the other hand, in a case where the environmental map has not been completed due to occlusion caused by a ground object or the like or the presence of a lane that is out of the angle of view of the camera, the information for requesting to travel on the specific lane is included in the specific lane information. In addition, the specific lane information may include information for prompting to travel next time on a day of the week or a time different from the day or the time when traveled on the specific lane, so that the information may be output before the subject vehicle starts to travel next time.

As a result, in a case where it is possible to avoid the occurrence of occlusion when the subject vehicle travels next time, it becomes possible to complete the environmental map promptly as compared with a case where the occlusion occurs in the same section also when the subject vehicle travels next time.

(5) In the map generation apparatus 60 in the above (4), the determination unit 175, as the lane identification unit, further identifies which the specific lane or a driving lane adjacent to the specific lane corresponds to the driving lane on which the subject vehicle travels next time, based on the camera image IM to be recognized by the camera 1a when the subject vehicle travels next time in the section for which the incompletion has been determined by the determination unit 175. The second generation unit (the generation unit 174) generates the map of only the specific lane in accordance with an identification result by the determination unit 175, as the lane identification unit. More specifically, in a case where the driving lane when the subject vehicle travels next time is identified to correspond to either the specific lane or a driving lane adjacent to the specific lane, the second generation unit generates a map of only the specific lane.

With such a configuration, by generating and complementing the map of only the specific lane when the subject vehicle travels next time, it becomes possible to complete the environmental map promptly as compared with a case of generating and complementing a map of another driving lane other than the specific lane.

(6) The map generation apparatus 60 in the above (4) includes the controller 10, as an output unit, which outputs, to an external device (the navigation unit 6, the camera 1a as the exterior environment recognition unit 14, the input/output device 3, and the like), the information indicating the specific lane (the specific lane information) that has been identified by the determination unit 175, as the lane identification unit, in the section for which the incompletion has been determined by the determination unit 175.

With such a configuration, for example, it becomes possible to notify the driver of the lane on which the driver has to drive via the input/output device 3 or the like, and it becomes possible to output an instruction to change an imaging direction from the controller 10 to the camera 1a, so that the center of the angle of view of the camera 1a is located on the specific lane side when the subject vehicle travels next time. This enables a configuration of a map creation environment in which occlusion hardly occurs, and enables completion of the environmental map with a small number of driving times (in other words, a small number of times of performing the processing of FIGS. 4B and 4C).

The above embodiments can be modified in various modes. Hereinafter, modifications will be described.

### First Modification

The division line of the road, the traffic sign, the traffic light, and the like have been given as examples of the predetermined ground object from which the selection unit 172 does not select the feature point based on the camera image IM. However, if it is difficult to track the object in the camera images IM of a plurality of frames, the feature point of any ground object other than the above ground objects may not necessarily selected.

### Second Modification

In an embodiment, in order to easily understand the description for convenience, the processing illustrated in FIG. 4A has been described as the processing before the environmental map is created. However, also after the environmental map is created (after the completion of the environmental map is determined), the processing illustrated in FIG. 4A may be performed in parallel with the position recognition processing of the subject vehicle in FIGS. 4B and 4C. By also performing the processing after the environmental map is completed, for example, in a case where there is a change in the road environment, it becomes possible to reflect such information on the environmental map appropriately.

### Third Modification

In an embodiment, an example in which the environmental map is generated as the internal map information to be used by the subject vehicle itself has been described. However, in the third modification, the environmental map generated by the subject vehicle may be provided for another vehicle via a cloud server, for example. That is, in the third modification, the environmental map is shared by a plurality of vehicles.

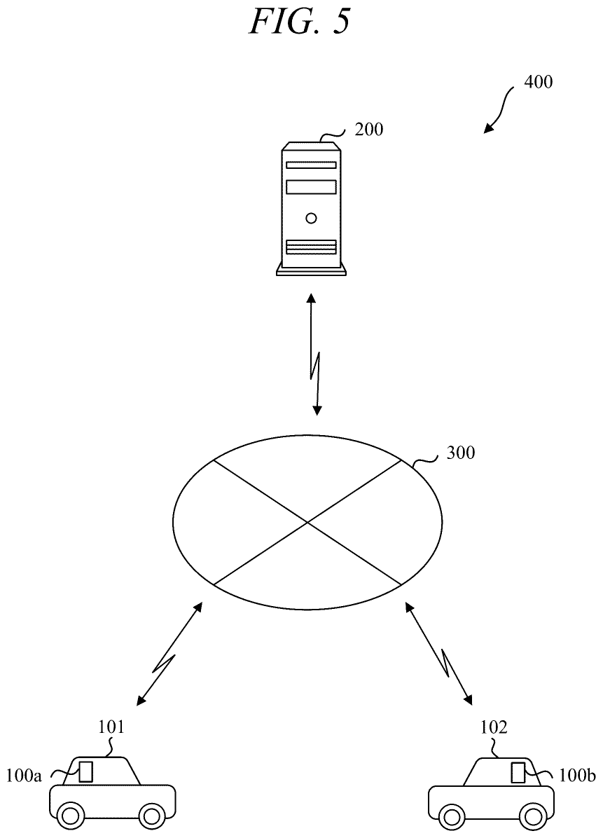

FIG. 5 is a diagram illustrating a configuration of a map generation system 400 according to the third modification. In FIG. 5, the map generation system 400 includes a server 200, which is connected with a communication network 300, and a vehicle control system 100a and a vehicle control system 100b, which are configured to be communicatively connected with the communication network 300. The vehicle control system 100a is the vehicle control system 100, which is mounted on the subject vehicle 101, and the vehicle control system 100b is the vehicle control system 100, which is mounted on another vehicle 102.

The server 200 is managed by, for example, a business entity or the like that provides an information sharing service of environmental maps. The configurations of the vehicle control systems 100a and 100b are similar to that of the vehicle control system 100 in the above-described embodiment.

The vehicle control systems 100a and 100b are each connected with the communication network 300, such as a wireless communication network, the Internet, and a telephone network, via the communication unit 7.

Although FIG. 5 illustrates two vehicles of the subject vehicle 101 and another vehicle 102, the number of vehicles connectable with the communication network 300 is not limited to two, and there may be a large number of vehicles.

The vehicle control systems 100a and 100b of the subject vehicle 101 and another vehicle 102 each transmit information of the environmental map of its own vehicle stored in the memory unit 12 to the server 200 via the communication unit 7 at a predetermined transmission timing. In addition, the transmission timing may be appropriately set by a driver, for example, once every week or every predetermined driving distance.

The server 200 includes a memory unit (database), not illustrated, that stores information of the environmental maps, when the information of the environmental map is transmitted from the vehicle control systems 100a and 100b, which are respectively mounted on the subject vehicle 101 and another vehicle 102.

In addition, the server 200 includes a processing unit such as a CPU (microprocessor), not illustrated. Upon receipt of a request for the information of the environmental map from the vehicle control systems 100a and 100b, which are respectively mounted on the subject vehicle 101 and another vehicle 102, the processing unit functions of reading the information of the environmental map of the area where the vehicle of a request source is traveling from the above database, and transmitting the information to the vehicle of the request source.

In the third modification, for example, when a command from a driver who requests the server 200 for the information of the environmental map is input via the input/output device 3, the controller 10 of the subject vehicle 101 or the like requests the server 200 for the information of the environmental map of the area where the subject vehicle 101 or the like is traveling. In this situation, it is assumed that the server 200 is notified of position information and information indicating the advancing direction of the subject vehicle 101 or the like. This enables the server 200 to transmit the information of the corresponding environmental map to the vehicle of the request source.

Note that the subject vehicle 101 or the like may transmit the recognition information that has been acquired by the subject vehicle 101 or the like to the server 200 together with the information of the environmental map or instead of the information of the environmental map.

The server 200 also stores, in the database, the recognition information that has been acquired by the subject vehicle 101 or the like. Upon receipt of a request for the information of the environmental map and/or the recognition information from the subject vehicle 101 or the like, the server 200 reads the information of the environmental map and/or the recognition information of the area where the vehicle of a request source is traveling from the database, and transmits the information of the environmental map and/or the recognition information to the vehicle of the request source.

When the vehicle of the request source acquires, from the server 200, the recognition information of a section where the map is incomplete in the vehicle, it becomes possible to generate an environmental map, based on the recognition information that has been acquired.

The map generation system 400 in the third modification that has been described heretofore includes the map generation apparatus 60 described above, and the server 200 as an external server configured to be communicable with the subject vehicle 101 and the like. The server 200 stores the recognition information that has been acquired by the subject vehicle 101 and another vehicle 102 and the information of the environmental maps that have been generated by the subject vehicle 101 and another vehicle 102, and provides the subject vehicle 101 and/or another vehicle 102 with the information, by using the recognition information and/or information of the environmental map that have been stored.

With such a configuration, an operation range of the environmental map generated by the subject vehicle 101 or the like is enlarged, as compared with a case where the environmental map is used only by its own vehicle, so that convenience is further improved.

Note that the environmental map may be configured to be switchable between a case where the environmental map is shared with another vehicle and a case where the environmental map is used only by the subject vehicle.

The above embodiment can be combined as desired with one or more of the above modifications. The modifications can also be combined with one another.

According to the present invention, it becomes possible to appropriately generate a map necessary for safe vehicle control.

Above, while the present invention has been described with reference to the preferred embodiments thereof, it will be understood, by those skilled in the art, that various changes and modifications may be made thereto without departing from the scope of the appended claims.

What is claimed is:

1. A map generation apparatus comprising:
a sensor configured to detect an exterior environment situation of a subject vehicle; and
a microprocessor and a memory coupled to the microprocessor, wherein the microprocessor is configured to perform:
recognizing a surrounding environment based on detection data of the sensor;
generating a map based on recognition information acquired in the recognizing;
estimating a position of the subject vehicle on the map;
determining completion or incompletion of the map; and
storing map information indicating the map, wherein
the microprocessor is configured to perform the generating including: generating the map of a driving section based on the recognition information; storing, in the memory, the map information corresponding to a completion section determined that the map is complete; and storing, in the memory, section information indicating an incompletion section determined that the map is incomplete, together with position information indicating the position of the subject vehicle, and
the generating further including: when the subject vehicle travels next time on the incompletion section, generating a map of the incompletion section based on the recognition information acquired based on the detection data of the sensor; adding map information indicating the map of the incompletion section to the map information stored in the memory; and rewriting the section information stored in the memory.

2. The map generation apparatus according to claim 1, wherein
the microprocessor is configured to further perform
conducting self-driving control for automatically controlling at least acceleration and deceleration of the subject vehicle, with the map information stored in the memory; and
inputting information indicating that a degeneration control of the self-driving control has been conducted or that an intervention of driving operation by a driver of the subject vehicle has been conducted, and
the microprocessor is configured to perform
the determining including determining the incompletion, when the information is input while the self-driving control is being conducted.

3. The map generation apparatus according to claim 1, wherein
the microprocessor is configured to perform
the determining including determining the incompletion, in a case where the recognition information is insufficient in either information about a driving lane adjacent to a driving lane on which the subject vehicle travels or information about a ground object on a side of a road on which the subject vehicle travels.

4. The map generation apparatus according to claim 1, wherein
the microprocessor is configured to perform
the determining including identifying, as a specific lane, a driving lane on which the subject vehicle has traveled, based on the position of the subject vehicle estimated in the incomplete section.

5. The map generation apparatus according to claim 4, wherein
the microprocessor is configured to perform
the determining including further identifying which the specific lane or a driving lane adjacent to the specific lane corresponds to a driving lane on which the subject vehicle travels next time, based on the recognition information, when the subject vehicle travels next time in the incompletion section, and
the generating including generating the map of only the specific lane in accordance with an identification result of the specific lane.

6. The map generation apparatus according to claim 4, wherein
the microprocessor is configured to further perform
outputting, to an external device, specific lane information indicating the specific lane in the incompletion section.

7. The map generation apparatus according to claim 6, wherein
the specific lane information includes information for requesting the driver to drive on the specific lane or a driving lane different from the specific lane.

8. The map generation apparatus according to claim 6, wherein
the specific lane information includes information for requesting the driver to travel next time on a day of a week or a time different from a day or a time when the subject vehicle has been traveled on the specific lane.

9. A map generation system comprises:
a map generation apparatus according to claim 1; and
an external server configured to be communicable with the subject vehicle, wherein
the microprocessor is a first microprocessor, the memory is a first memory, and the external server comprises:
a second microprocessor and a second memory coupled to the second microprocessor, wherein
the second memory stores the recognition information acquired by the subject vehicle and another vehicle and the map information generated by the subject vehicle and the other vehicle, and
the second microprocessor is configured to perform
providing at least one of the subject vehicle and the other vehicle with at least one of the recognition information and the map information stored in the second memory.
